(19) United States
(12) Patent Application Publication
(10) Pub. No.: US 2004/0198624 A1
(43) Pub. Date: Oct. 7, 2004

(54) Use of polyoxypropylene/polyoxyethylene terpene compounds as degreasing agents for hard surfaces

(76) Inventors: Jean-Luc Joye, Cranbury, NJ (US); Jean-Guy Le Helloco, Levallois-Perret (FR)

Correspondence Address: Rhodia Inc., CN 7500, 259 Prospect Plains Road, CRANBURY, NJ, 08512, US

(21) Appl. No.: 10/820,929

(22) Filed: Apr. 8, 2004

Related U.S. Application Data
(63) Continuation of application No. 10/049,575, filed on May 15, 2002, now abandoned.
Application No. 10/049,575 is a 371 of international application No. PCT/FR00/02325, filed on Aug. 16, 2000.

(30) Foreign Application Priority Data
Aug. 17, 1999 (FR) 99/10559

(51) Int. Cl. C11D 1/00

(52) U.S. Cl. 510/245

(57) ABSTRACT

The invention concerns the use in degreasing/cleansing applications of hard surfaces, such as metal surfaces, of at least a compound derived from a terpene and comprising a number of oxypropylene units ranging between 3 and 5, and a number of oxyethylene units ranging between 6 and 10, exclusively. The compound is provided with a concentration lower than 10 g/l, more particularly between 0.01 and 5 g/l, when used.

The present invention relates to the use of terpene compounds comprising oxypropylene and oxyethylene units as agents for degreasing/cleaning hard surfaces, more particularly metal surfaces.

The field of cleaning/degreasing metal surfaces demands very good performance in particular as regards the degreasing power of the composition employed, and its non-foaming capacity. It should also be noted that such results are usually demanded even though the service conditions are very difficult. Spray methods encourage the appearance of foam because the treatment liquor is applied under pressure.

The compounds currently used in this field are mainly ethoxylated alkylphenols. Such compounds have highly satisfactory intrinsic degreasing properties. However, they suffer from a substantial disadvantage, namely encouraging foam formation. This undesirable phenomenon for this application is reduced by adding an antifoaming agent such as a linear alkoxylated alcohol. However, the presence of that type of compound reduces the degreasing activity of the ethoxylated alkylphenol in a manner that is not negligible and may be substantial. It is not possible to compensate for the loss of activity by adding sufficient additional alkylphenol to recover the initial level of activity.

International patent application WO-A-96/01245 describes alkoxylated terpene compounds presented as good degreasing agents that do not greatly encourage foam formation. The compounds of the examples are derivatives of nopol or arbanol type terpene compounds, and contain 0 to 2 oxypropylene moieties and 3.3 to 10.3 oxyethylene moieties.

Such compounds, the importance of which is not questioned here, do not produce good results, however, in the very particular application of treating hard surfaces, in particular metal surfaces. They do not simultaneously satisfy the two criteria required in this field, namely a high degreasing activity and antifoaming action. This means that the amount of compound in the formulation must be increased and/or an antifoaming agent has to be added, with known disadvantages. It is also stated that despite the addition of large quantities of such compounds, the degreasing levels achieved are at most equivalent to those of ethoxylated alkylphenols.

As can be seen, compounds with a very high degreasing capacity, which do not cause the appearance of a large amount of foam, must be available. The use of such compounds would have the double advantage of not making the use of large quantities of this compound necessary, and not requiring the addition of supplemental compounds such as antifoaming agents.

The aim of the present invention is to propose the use of a particular terpene compound that satisfies the double criteria cited above, in application to the cleaning/degreasing of hard surfaces, in particular metal surfaces, at low concentrations.

The present invention concerns the use, in cleaning/degreasing hard surfaces, of at least one compound employed in a concentration in the range 0.01 to 10 g/l during use of said compound, having the following formula:

Z—X—[CH(R³)—CH(R⁴)—O]ₙ—[CH₂CH₂—O]ₚ—R⁵

in which formula:

Z represents a bicyclo[a,b,c]heptenyl or bicyclo[a,b,c]heptyl radical, where:

a+b+c=5

a=2, 3 or 4;

b=2 or 1;

c=0 or 1;

said radical optionally being substituted by at least one C₁-C₆ alkyl radical and comprising a backbone Z selected from those indicated below, or the corresponding backbones minus the double bond:

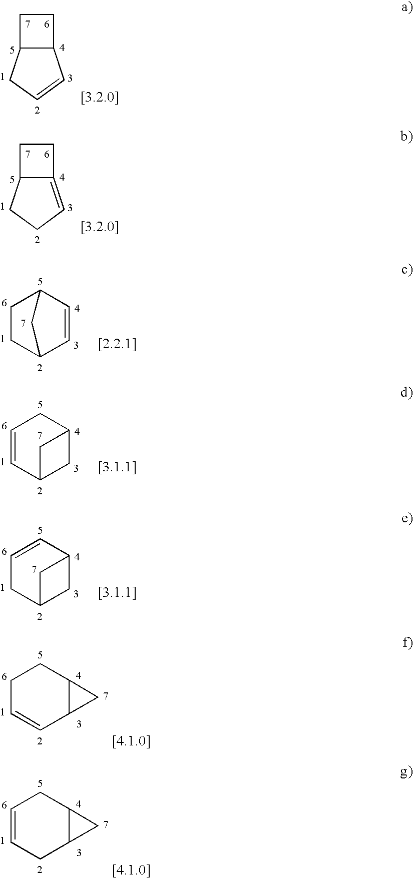

X represents —CH₂—C(R¹)(R²)—O—or —O—CH(R^{′1})—CH(R^{'2})—O—, in which:

R¹, R², R^{′1} and R^{'2}, which may be identical or different, represent hydrogen or a linear, branched or cyclic, saturated or unsaturated C₁-C₂₂ hydrocarbon radical, preferably C₁-C₆;

R³ and R⁴, which may be identical or different, represent hydrogen or a linear, branched or cyclic, saturated or unsaturated C₁-C₂₂ hydrocarbon radical, provided that at least one of radicals R³ or R⁴ is other than hydrogen;

R⁵ represents hydrogen, linear, branched or cyclic, saturated or unsaturated, aromatic or non aromatic C₁-C₂₂ hydrocarbon radical,, which may be substituted, or a group selected from the following:

—SO₃M

—OPO₃(M)₂

—(CH₂)ᵣ—COOM

—(CH₂)_{z}—SO₃M

in which formulae:

M represents hydrogen, an alkali metal or an ammonium function N(R)₄⁺, in which R, which may or may not be identical, represents hydrogen or a linear, branched or cyclic, saturated or unsaturated C₁-C₂₂ hydrocarbon radical,, which may be hydroxylated;

r is in the range 1 to 6;

z is in the range 1 to 6;

n is a whole or fractional number in the range 3 to 5 inclusive;

p is a whole or fractional number in the range 6 to 10, limits excluded.

Further advantages and characteristics of the present invention will become more clear from the following description and examples.

Firstly, the compounds employed in the present invention will be described.

A first type of compound is defined by formula (I), in which X is equal to —CH₂—C(R¹)(R²)—O—.

This compound, hereinafter termed (Ia), corresponds to the following formula:

Z—CH₂—C(R¹)(R²)—O—[CH(R³)—CH(R⁴)—O]ₙ—[CH₂CH₂—O]ₚ—R⁵

in which Z, R¹, R², R³, R⁴, R⁵, n and p have the meanings given above.

In one preferred implementation of the invention, radical Z is selected from radicals with formulas c) to g).

It should be noted that radical Z is more particularly attached to the remainder of the chain via one of carbon atoms 1 to 6; carbon atoms 1, 5 and 6 are preferred.

Further, radical Z can be substituted on at least one of its carbon atoms by two C₁-C₆ alkyl radicals, preferably two methyl radicals.

More particularly, the 7 carbon is substituted by these two alkyl radicals, more precisely two methyl radicals.

One preferred compound of the invention is, therefore, constituted by a compound in which radical Z corresponds to one of those appearing in figures c) to g), and more preferably radicals d) and e); radical Z being substituted by two methyl radicals located on the 7 carbon.

In a more advantageous implementation of the invention, radical Z corresponds to formulas d) or e), bonded to the remainder of the chain via the 5 or 1 carbon, and carrying two methyl substituents on the 7 carbon.

Preferably, R¹, R², which may or may not be identical, represent a hydrogen or a methyl radical. Preferably, R¹, R² represent a hydrogen atom.

As indicated above, radicals R³ and R⁴, which may be identical or different, represent hydrogen or a linear, branched or cyclic, saturated or unsaturated C₁-C₂₂ hydrocarbon radical, provided that at least one of radicals R³ or R⁴ is other than hydrogen.

More precisely, said radicals represent hydrogen or a C₁-C₆ alkyl radical, preferably the methyl radical or the ethyl radical, provided that at least one of these two radicals is other than hydrogen. Preferably, one of the radicals represents hydrogen, and the other represents a methyl radical.

R⁵ represents hydrogen, a linear, branched or cyclic, saturated or unsaturated, aromatic or non aromatic C₁-C₂₂ hydrocarbon radical, which may be substituted, or a group selected from the following: —SO₃M, —OPO₃(M)₂, —(CH₂)ᵣ—COOM, —(CH₂)_{z}—SO₃M, in which formulae:

M represents hydrogen, an alkali metal or an ammonium function N(R)₄⁺, in which R, which may or may not be identical, represents hydrogen or a linear, branched or cyclic, saturated or unsaturated C₁-C₂₂ hydrocarbon radical,, which may be hydroxylated;

r is in the range 1 to 6;

z is in the range 1 to 6.

When R⁵ is a hydrocarbon radical, this latter is more particularly a C₁-C₆ alkyl radical or an alkylphenyl radical, optionally substituted by a halogen (for example chlorine).

Preferably, R⁵ is a hydrogen atom.

Finally, n is a whole or fractional number in the range 3 to 5 inclusive and p is a whole or fractional number in the range 6 to 10, limits excluded.

In a first particular implementation of the present invention, the value of n is 3.

Further, the value of p is more particularly in the range 6.2 to 7, limits included. Preferably, p is in the range 6.3 to 7, limits included.

In a second particular implementation of the invention, n is in the range 4 to 5, limits included.

Further, the value of p is preferably in the range 7 inclusive to 10 exclusive, preferably in the range 8 inclusive to 10 exclusive.

A second type of compounds is defined by formula (I) in which X represents —O—CH(R^{′1})—CH(R^{′2})—O—.

Thus, this compound, hereinafter termed compound (Ib), corresponds to the following formula:

Z—O—CH(R^{′1})—CH(R^{′2})—O—[CH(R³)—CH(R⁴)—O]ₙ—[CH₂CH₂—O]ₚ—R⁵

in which formula Z, R^{′1}, R^{′2}, R³, R⁴, R⁵, n and p have the meanings given above.

In one preferred implementation of the invention, radical Z corresponds to radical c), the bicyclic compound containing no double bond.

Here again, it should be noted that radical Z is more particularly attached to the remainder of the chain via one of carbon atoms 1 to 6; carbon atoms 1, 3, 4 or 6 are preferred.

Further, radical Z can be substituted on at least one of its carbon atoms by two C₁-C₆ alkyl radicals, preferably two methyl radicals.

More particularly, the 7 carbon is substituted by these two alkyl radicals, more precisely two methyl radicals.

Further, carbon atoms 2 or 5 of radical Z carry a C₁-C₆ substituent, preferably a methyl radical.

More particularly, and as mentioned above, radicals R^{′1} and R^{′2}, which may be identical or different, represent hydrogen or a linear, branched or cyclic, saturated or unsaturated C₁-C₂₂ hydrocarbon radical, provided that one of the two is other than hydrogen.

In a particular implementation of the invention, said radicals represent hydrogen or a C₁-C₆ alkyl radical, preferably the methyl radical.

The foregoing regarding radicals R³, R⁴ and R⁵ and the values of n and p and the preferred variations concerning these values also apply in this case and will not be repeated.

One particularly advantageous implementation of the invention is constituted by the use of compounds of type (Ia) described above.

The compounds of the invention can be prepared by reacting:

To obtain compounds (Ia), a reactant with formula (IIa):

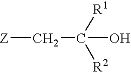

or to obtain compound (Ib), a reactant with formula (IIb):

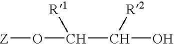

with firstly, a reactant with formula (IIIop):

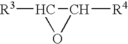

then, secondly, with a reactant with formula (IIIoe)

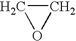

radicals Z, R¹, R², R³ and R⁴ having been defined above.

The reaction can be carried out in the presence of a catalyst.

Suitable catalysts that can be cited are strong bases such as alkali metal or alkaline-earth metal hydroxides or quaternary ammonium hydroxides of the N(R)₄⁺ type in which R, which may or may not be identical, represents hydrogen or a C₁-C₆ alkyl radical, preferably methyl or ethyl. Sodium, potassium and tetramethylammonium hydroxides are suitable for carrying out this reaction.

It is also possible to use catalysts selected from alkali metal or alkaline-earth metal alkoxides, such as sodium or potassium methylate, ethylate or teriobutylate. It should be noted that it is also possible to use primary, secondary or tertiary amines as the catalyst, preferably aliphatic amines, such amines possibly comprising other functions such as ether functions. An example of a catalyst of this type that can be cited is N,N-dimethyllaurylamine.

In the case of a basic catalyst, the quantity is more particularly in the range 0.5 to 40 mg with respect to the final product weight.

It is possible to carry out this reaction in the presence of a Lewis acid such as BF₃ (gaseous or in solution in an ether), SnCl₄, or SbCl₅.

More particularly, the quantity of acid catalyst is in the range 0.1 to 10 mmoles per mole of reactant (IIa) or (IIb).

Contact is carried out at a temperature that is sufficient for the reaction to occur. By way of indication, the temperature is more than 100° C., more particularly in the range 120° C. to 250° C. and preferably in the range 150° C. to 200° C.

Advantageously, the reaction is carried out in an atmosphere that is inert under the reaction conditions, such as nitrogen, or a rare gas such as argon, or carbon monoxide. Nitrogen is preferred.

The reaction can be carried out at atmospheric pressure, under reduced pressure or under a slight over pressure. Normally, the pressure is in the range 1 to 4 bars.

The preparation of reactants (IIa) and (IIb) has been described in WO-A-96/01245, reference to which should be made.

The quantities of compounds (IIIop) and (IIIoe) are calculated as a function of the characteristics of formula (I), more particularly the desired values of n and p. These two compounds are introduced in succession, to obtain a block compound with formula (I).

At the end of the reaction, the reaction mixture is preferably neutralised to obtain a pH in the range 5 to 8, preferably 6 to 7.

Neutralisation is carried out using acetic acid, a hydroxide, sodium carbon or bicarbonate, depending on the nature of the catalyst used in the reaction.

At the end of this reaction, compound (I) is such that radical R⁵ is hydrogen.

It is possible to carry out a functionalisation step of said radical, i.e., a step aimed at transforming the terminal hydrogen into another radical R⁵ as defined above. An etherification or esterification operation can be carried out on the terminal hydrogen; this step is well known per se; it is preferably carried out after neutralisation.

The following can be prepared:

ether sulphates (R⁵=—SO₃M), as described in British patent GB-A-1 111 208 or United States patent U.S. Pat. No. 3,392,185;

ether phosphates (R⁵=—OPO₃(M)₂), as described in U.S. Pat. No. 3,331,896;

ether carboxylates (R⁵=—(CH₂)—COOM), as described in U.S. Pat. No. 2,623,900 or U.S. Pat. No. 2,983,738;

ether sulphonates (R⁵=—(CH₂)₂—SO₃M), as described in U.S. Pat. No. 2,115,192, U.S. Pat. No. 4,978,780 or K. SUGA, Austr. J. Chem., 21, 2333 (1968)

alkyl ethers (R⁵=hydrocarbon radical) as described in U.S. Pat. No. 2,913,416.

Further details regarding functionalisation modes are described in WO-A-96/01245.

The compounds of the invention are thus used as a degreasing agent for hard surfaces and more particularly for metal surfaces.

The compounds of the invention can be used in the metal treatment industry, and also in any application in which such surfaces are degreased, such as degreasing oil wells or oil production platforms.

As indicated above, the compound employed in accordance with the invention is used in a quantity in the range 0.01 to 10 g/l, at the time of use.

More particularly, when degreasing metal plates or sheets, the compound concentration is in the range 0.01 to 5 g/l during use.

In the oil production field, more particularly platform degreasing, the concentration of compounds is in the range 0.01 to 10 g/l at the time of use of compounds used in accordance with the invention.

With more particular regard to well cleaning, the compound of the invention is used in a concentration that is preferably in the range 0.01 to 5 g/l.

The aqueous degreasing or detergent media containing the compounds of the invention are preferably used at a temperature that is at least of the order of their cloud point.

The degreasing formulations for metal plates or sheets in an alkaline medium comprise, in addition to the compound of the invention, an alkaline lye comprising at least one of the following compounds:

at least one pH control agent such as a hydroxide, carbonate, sesquicarbonate, or alkali metal or alkaline-earth metal bicarbonate;

at least one polyphosphate such as a tripolyphosphate, pyrophosphate, orthophosphate or hexametaphosphate of an alkali metal, alkaline-earth metal, N(R₄⁺) type ammonium where R represents hydrogen, a C₁-C₄ alkyl radical that may optionally contain an oxygen atom,;

at least one alkali metal silicate such as alkali metal metasilicates, anhydrous or otherwise, or mixtures thereof.

The concentration of alkaline lye during use is in the range 1 to 100 g/l, more particularly in the range 5 to 20 g/l.

The formulations can also comprise:

at least one hydrotropic electrolyte such as benzenesulphonates, mono- or di-alkyl (C₁-C₄) benzene sulphonates, toluene-, xylene- or cumene-sulphonates, alcohols or glycols;

at least one sequestrating agent such as nitriloacetic acid, ethylenediamine tetraacetic acid, ethylenediamine tetramethylphosphonic acid, nitrilotrimethylene phosphonic acid or salts thereof;

buffer agents such as alkanolamines, ethylenediamine;

metal corrosion inhibitors.

The concentrations of these compounds can lie within the normal ranges for this field. However, by way of illustration, the amount of each of the compounds is from 0 to 1.5 g/l at the time of use.

In addition to the compound of the invention, aqueous compositions used to degrease oil platforms can comprise,:

at least one hydrotropic electrolyte such as benzenesulphonates, mono- or di-alkyl (C₁-c4) benzene sulphonates, toluene-, xylene- or cumene-sulphonates, alcohols and glycols;

at least one pH control agent such as alkali metal carbonates, sesquicarbonates or bicarbonates;

additives such as enzymes, metal corrosion inhibitors.

Here again, the concentrations of these compounds are within the normal range for the field. However, an illustrative concentration for each of the compounds is from 0 to 1.5 g/l at the time of use.

In addition to the compound of the invention, aqueous media employed to clean oil wells can comprise:

at least one pH adjusting agent such as alkali metal carbonates, sesquicarbonates or bicarbonates, or alkali metal or alkaline-earth metal hydroxides;

additives such as enzymes in an amount of up to 5% of the total aqueous composition weight, or metal corrosion inhibiting agents;

if necessary, weighting agents to maintain a satisfactory hydrostatic pressure in the well.

Examples of such compounds that can be cited are soluble or at least partially soluble salts such as alkali metal or alkaline-earth metal halides. It is also possible to use alkali or alkaline-earth metal sulphates, carbonates, bicarbonates, silicates, or phosphates, used alone or as a mixture. It is also possible to use organic acid salts such as alkali metal or alkaline-earth metal formates or acetates.

Although not preferred, it is possible to use insoluble salts such as alkaline-earth metal sulphates, silicates or carbonates; or alkaline-earth metal or zinc bromides;

hydrocolloids such as polysaccharides of plant origin, such as polygalactomannanes, cellulose, starches and their derivatives; or polysaccharides of bacterial origin such as xanthan gum or deacetylated derivatives.

Although not preferred, the scope of the invention encompasses adding surfactants (anionic, cationic, zwitterionic, amphoteric), preferably low foaming surfactants, and other additives to the formulations described above.

Non-limiting examples illustrating the invention will now be given.

### EXAMPLE 1

This example concerns the synthesis of 6,6-dimethylbicyclo[3.1.1]hept-2-ene-2-ethanol containing differing numbers of oxypropylene (OP) units and oxyethylene (OE) units.

6,6-dimethylbicyclo[3.1.1]hept-2-ene-2-ethanol comprising x oxypropylene (OP) units and y oxyethylene (OE) units was synthesised as follows:

the 6,6-dimethylbicyclo[3.1.1]hept-2-ene-2-ethanol (nopol) used is sold by Fluka.

The nopol (6 moles) and an aqueous potassium hydroxide solution (50%, 3.1 g) were introduced into a 5 litre ethoxylation reactor.

The reaction medium was dehydrated at 120° C. in a stream of nitrogen.

It was than heated to 170° C. and propylene oxide (x molar equivalents) was introduced. Once the propylene oxide had been introduced, ethylene oxide was added (y molar equivalents).

The reaction medium was then cooled and neutralised by adding acetic acid to a pH of 7. The liquid was filtered through absorbent clay (Clarcel DIC).

Table of compounds synthesised using the method described above:

| | | |
|---|---|---|
| Compounds | Number of OP (x) | Number of OE (y) |

Invention

| | | |
|---|---|---|
| 1 | 3 | 6.3 |
| 2 | 3 | 7 |
| 3 | 3 | 7.5 |
| 4 | 4 | 7 |
| 5 | 4 | 8 |
| 6 | 5 | 7 |
| 7 | 5 | 8 |

Comparative

| | | |
|---|---|---|
| 8 | 3 | 6 |
| 9 | 3 | 10 |
| 10 | 2 | 5 |

### EXAMPLE 2

This example compares the degreasing properties of compounds 1 and 3 of the invention and comparative compounds 10, 11 and 12, and those obtained with defoamed Igepal NP 10

Greasing

Pre-degreased “Q-Panel” Stock n° R-36 type “Dull matt finish” 0.8×76×152 mm steel plates were immersed for 2 minutes in a whole lubricating oil formulated for rolling steel sheets for automobiles, sold by Quaker Chemicals as QUAKER 6130 N, then suspended for 24 hours to drain.

Cleaning and Rinsing

The greased plates were introduced into a CIEMME LARO 350 degreasing spray machine. The degreasing temperature was 45° C. and the pressure was 2 bars.

Before recording the degreasing quality, each face of the plates was rinsed for 5 seconds in a stream of water flowing at 2 m/min.

Degreasing Medium p A basic degreasing medium (pH 12-13) was prepared by diluting 20 g/l of an aqueous lye containing 45% by weight of active substance constituted by equal weights of potassium hydroxide, sodium metasilicate (SIMET GA5, granules of anydrous metasilicate and pentahydrated metasilicate sold by Rhodia Chimie) and tetrapotassium pyrophosphate and adding 1 g/l of test compound.

The results are shown in the table below:

| Compound | Degresing time(*) |
|---|---|
| 1 | 30 seconds |
| 3 | 30 seconds |
| 8 (comparative) | 45 seconds |
| 9 (comparative) | 55 seconds |
| 10 (comparative) | >2 minutes |
| Defoamed Igepal (**) | 45 seconds |

(*)The degreasing time is the time required to completely coat the two faces with a continuous film of water.
(**) Defoamed Igepal is a mixture of Igepal CO-660 (nonylphenol 10 OE) and Miravon B12DF (50/50).

Clearly, the product of the invention is more active than any of the agents employed for comparative purposes.

### EXAMPLE 3

This example compares the degreasing properties of compounds 4 to 7 of the invention and those obtained with non-defoamed Igepal NP 10.

Greasing

An oil with trade name Pennzoil 80W-90 sold by Pennzoil Products Company (Houston, Tex.) was applied to pre-degreased 0.8×24×101 mm steel plates using a brush to obtain an oil coating of about 0.015 g/cm². They were then stored in air for 24 hours.

The quantity of oil was measured by weighing the plate before and after application of the oil

Cleaning and Rinsing

The plate was immersed in one litre of degreasing medium, with magnetic stirring (100 rpm) at 50° C. for 10 minutes.

Before reading the degreasing quality, each face of the plates was rinsed for 5 seconds in a stream of water flowing at 2 ml/min, then dried at 80° C.

The efficacy of the operation was calculated by weighing the plate before and after treatment with the degreasing medium.

Degreasing Medium

A basic degreasing medium (pH 12-13) was prepared by diluting 20 g/l of an aqueous lye containing 1.5 g/l of tetrapotassium pyrophosphate and adding 1 g/l of test compound.

The results are shown in the table below:

| Compound | % of oil removed |
|---|---|
| 4 | 58 |
| 5 | 62 |
| 6 | 54 |
| 7 | 72 |
| Igepal (*) | 51 |

(*) Igepal is Igepal CO-630, a nonylphenol 9 OE.

Clearly, the product of the invention is more active than the agents used for comparative purposes.

### EXAMPLE4

This example compares the foaming properties of compounds obtained in Examples 1 to 9, with those obtained with comparative compounds, namely defoamed Igepal and Igepal alone.

Foam Test:

A basic degreasing medium (pH 12-13) was prepared by diluting 20 g/l of an aqueous lye containing 45% by weight of active substance constituted by equal weights of potassium hydroxide, sodium metasilicate (SIMET GA5, granules of anydrous metasilicate and pentahydrated metasilicate sold by Rhodia Chimie) and tetrapotassium pyrophosphate and adding 1 g/l of test compound.

The test was carried out at 50° C.

The foam was obtained by stirring 900 g of solution using a turbomixer (40 mm turbine, speed 2000 rpm) for 5 minutes.

The foam level was recorded for a sample after allowing to stand for 5 minutes.

The results are shown in the table below:

| Compound | Foam level |
|---|---|
| 1 | 20 ml |
| 3 | 70 ml |
| 4 | 20 ml |
| 5 | 50 ml |
| 6 | 20 ml |
| 7 | 30 ml |
| Defoamed Igepal (*) | 70 ml |
| Igepal alone (**) | 950 ml |

(*) Defoamed Igepal is a mixture of Igepal CO-660 (nonylphenol 10 OE) and Miravon B12DF (50/50).
(*) Igepal: Igepal CO-660 (nonylphenol 10 OE).

The above table, in combination with the degreasing results from the preceding examples, show that only the compounds of the invention satisfy the double criterion of high degreasing power and a foaming level compatible with use in degreasing metal plates.

1-13. (canceled)

14. A process for degreasing a hard metal surface, comprising the step of using an aqueous medium comprising at least one compound employed in a concentration of from 0.01 to 10 g/l, having the following formula (I):
Z—X—[CH(R³)—CH(R⁴)—O]ₙ—[CH₂CH₂—O]ₚ—R⁵ (I)
wherein:
—Z represents
a group having the following formula: 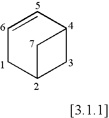 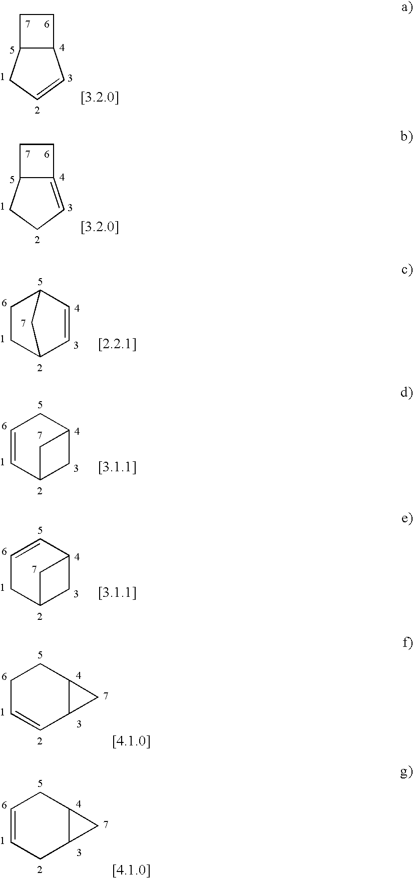
Wherein:
X represents —CH₂—CH₂—O—,
R³ and R⁴, which are identical or different, represent hydrogen or a methyl group, provided that at least one of groups R³ or R⁴ is other than hydrogen,
R⁵ represents hydrogen,
n is an integer or a fractional number from 3 to 5 inclusive, and
p is an integer or a fractional number from 6 to 10, limits excluded.

15. A process according to claim 14, wherein n is equal to 3.

16. A process according to claim 14, wherein p is from 6.2 to 7, limits included.

17. A process according to claim 16, wherein p is from 6.3 to 7, limits included.

18. A process according to claim 17, wherein n is from 4 to 5.

19. A process according to claim 14, wherein p is from 7 inclusive to 10 exclusive.

20. A process according to claim 19, wherein p is from 8 inclusive to 10 exclusive.

21. A process according to claim 14, wherein the hard surface is a metal plate, and the concentration of compound is from 0.01 to 5 g/l.

22. A process according to claim 14, the hard surface is a platform, and the concentration of compound is in the range from 0.01 to 10 g/l.
